(19) United States
(12) Patent Application Publication
(10) Pub. No.: US 2010/0089917 A1
(43) Pub. Date: Apr. 15, 2010

(54) FOLDABLE MOBILE STORAGE CONTAINER

(76) Inventors: Danny L. Gilbert, Monticello, IN (US); Francis S. Smidler, Lafayette, IN (US); Michael L. Thoma, Lafayette, IN (US); Robert L. Hancock, Lafayette, IN (US); Jeremy M. Schrader, Cayuga, IN (US)

Correspondence Address: BARNES & THORNBURG LLP, 11 SOUTH MERIDIAN, INDIANAPOLIS, IN, 46204, US

(21) Appl. No.: 12/577,490

(22) Filed: Oct. 12, 2009

Related U.S. Application Data
(60) Provisional application No. 61/104,953, filed on Oct. 13, 2008.

(51) Int. Cl. B65D 6/00; B31B 1/26

(52) U.S. Cl. 220/6; 493/405

(57) ABSTRACT

A foldable mobile storage container includes a floor assembly, first and second sidewall assemblies, a rear frame assembly, a front end assembly, and a roof assembly. The first and second sidewall assemblies, the rear end assembly, and the front end assembly are each pivotally coupled to the floor assembly to allow the mobile storage container to be moved between a use configuration for storing items therein and a stowed configuration.

This application claims priority under 35 U.S.C. §119(e) to U.S. Provisional Patent Application Ser. No. 61/104,953, filed Oct. 13, 2008 entitled FOLDABLE MOBILE STORAGE CONTAINER, the entirety of which is hereby incorporated by reference herein.

### FIELD OF THE INVENTION

The present invention relates generally to storage containers, such as mobile storage containers. In particular, the present invention relates to foldable storage containers.

### BACKGROUND

Many storage containers, such as mobile storage containers, are configured to be assembled in order to store goods therein and disassembled for ease of transportation, for example. In the assembled configuration, such storage containers may be rectangularly-shaped box-like structures constructed from multiple panels that are fastened together. Many such containers have a front end and a rear end each, and may have a door formed therein in order to provide access to the inside storage portion of the container.

### SUMMARY

The present invention may comprise one or more of the features recited in the attached claims, and/or one or more of the following features and combinations thereof. One illustrative embodiment of a foldable mobile storage container is provided. The foldable mobile storage container includes a floor assembly, a first sidewall assembly pivotally coupled to the floor assembly, a second sidewall assembly pivotally coupled to the floor assembly, a rear end wall assembly pivotally coupled to the floor assembly, a front end wall assembly pivotally coupled to the floor assembly, and a roof assembly configured to be coupled to the first and second sidewall assemblies and to the rear and front end wall assemblies.

In one illustrative embodiment, the floor assembly may include a first hinge coupled to the first sidewall assembly and a second hinge coupled to the second sidewall assembly.

In another illustrative embodiment, the rear end wall assembly may include an outer door frame and first, second, and third door panels pivotally mounted to the door frame. Illustratively, the second door panel may be positioned between the first and third door panels. Further illustratively, the second door panel may be pivotalby mounted to the first door panel, the first door panel may be pivotalby mounted to the outer door frame, and the third door panel may be pivotalby mounted to the outer door frame. The rear end assembly includes a door handle assembly coupled to the second door panel. Further, the rear end assembly may includes a first spring-loaded latch coupled to the first door panel, a second spring-loaded latch coupled to the second door panel, and a third spring-loaded latch coupled to the third door panel.

In still other illustrative embodiment, the roof assembly may include an outer frame and a roof cap coupled to the outer frame to define a roof channel extending around the perimeter of the roof assembly. Illustratively, the roof channel may be configured to receive the first and second sidewall assemblies and the front and rear end assemblies therein. Further, the roof cap may illustratively include an inner wall, an outer wall, and an upper wall coupled to and positioned between the inner wall such that the roof channel is defined between the inner and the outer wall.

In yet another illustrative embodiment, the front end assembly may include an outer frame having first and second corner posts each including a front wall member and a sidewall member coupled to the front wall member and positioned generally transverse to the front wall member. Similarly, the rear end assembly may include an outer frame having first and second corner posts each including a front wall member and a side wall member coupled to the front wall member and positioned generally transverse to the front wall member.

In still another illustrative embodiment, the mobile storage container may be movable between a use configuration to define a storage area therein and a stowed configuration. Illustratively, the first and second sidewall assemblies and the front and rear end assemblies are in a generally vertical position when the mobile storage container is in the use position and are in a generally horizontal position when the mobile storage container is in the stowed position. Further, the first sidewall assembly may be positioned atop the floor assembly, the second sidewall assembly may be positioned atop the first sidewall assembly, the front and rear end assemblies each may be positioned atop the second sidewall assembly, and the roof assembly may be positioned atop both the front and rear end wall assemblies when the mobile storage container is in the stowed position.

According to yet another aspect of the present disclosure, a method of folding a mobile storage container from a use configuration defining a storage area therein to a stowed configuration includes removing a roof assembly of the mobile storage container, pivoting a first sidewall assembly from a generally vertical position to a generally horizontal position atop the floor assembly, pivoting a second sidewall assembly from a generally vertical position to a generally horizontal position atop the first sidewall assembly, pivoting a rear end assembly from a generally vertical position to a generally horizontal position atop the second sidewall assembly, pivoting a front end assembly from a generally vertical position to a generally horizontal position atop the second sidewall assembly, placing the roof assembly top the rear and front end assemblies.

In one illustrative embodiment, removing the roof assembly may be removed by using a fork lift. Further, the first and second sidewall assemblies may also be pivoted relative to the floor assembly by using a fork lift. Further, the front end assembly and the rear end assembly may be manually pivoted relative to the floor assembly to the stowed position.

According to still another aspect of the present disclosure, a foldable mobile storage container includes a floor assembly and first and second sidewall assemblies pivotally coupled to the floor assembly. The floor assembly includes a first hinge coupled to both the first sidewall assembly and the floor assembly. The floor assembly further includes a second hinge coupled to both the second sidewall assembly and the floor assembly. The mobile storage container is movable between a use configuration to define a storage area therein and a stowed configuration. In the stowed configuration the first and second sidewall assemblies are pivoted to a generally horizontal position atop the floor assembly.

In one illustrative embodiment, the floor assembly may include a third hinge coupled to the first sidewall assembly and a fourth hinge coupled to the second sidewall assembly. Further illustratively, each of the first, second, third, and fourth hinges may be pivot hinges including a first bracket coupled to the floor assembly and a second bracket coupled to one of the respective first and second sidewall assemblies.

In another illustrative embodiment, the mobile storage container may further include first and second end wall assemblies pivotally coupled to the floor assembly. Illustratively, a first pivot plate may of the first end wall assembly may be pivotably coupled via a first pivot pin to a side beam of the floor assembly. Similarly, a second pivot plate of the second end wall assembly may be pivotably coupled via a second pivot pin to the side beam may be coupled to a corner post of the second end wall assembly and the side beam of the floor assembly. Further illustratively, the front and rear end assemblies may be pivoted to a generally horizontal position when the mobile storage container is in the stowed configuration. The front and rear end assemblies may also be positioned atop the first and second sidewall assemblies when the mobile storage container is in the stowed configuration.

In still another illustrative embodiment, the first and second side wall assemblies may each include a plurality of metal wall panels.

In yet another illustrative embodiment, a roof assembly may be configured to be coupled to the first and second sidewall assemblies when the mobile storage container is in the use configuration, and uncoupled from and configured to lie atop the first and second sidewall assemblies when the mobile storage container is in the stowed configuration.

### BRIEF DESCRIPTION OF THE DRAWINGS

FIG. 1 is a front, perspective view of a mobile storage container in an assembled configuration;

FIG. 2 is a rear, perspective view of the mobile storage container of FIG. 1 in the assembled configuration;

FIG. 3 is a side view of the mobile storage container of FIGS. 1 and 2;

FIG. 4 is a side view of the mobile storage container in a stowed configuration;

FIG. 5 is a side view of an interior side of a sidewall assembly of the mobile storage container;

FIG. 6 is a front view of a strip assembly of the sidewall assembly shown in FIG. 5;

FIG. 7 is an end view of the sidewall assembly of FIGS. 5 and 6;

FIG. 8 is a perspective view of a floor assembly of the mobile storage container;

FIG. 9 is a sectional view taken along line 9-9 of FIG. 8;

FIG. 10 is a side view of the bottom wall of FIG. 8;

FIG. 11 is a perspective view of a front end wall assembly of the mobile storage container;

FIG. 12 is a front view of the inside of the front end wall assembly of FIG. 11;

FIG. 13 is a perspective view of a roof assembly of the mobile storage unit;

FIG. 14 is a bottom view of a roof frame of the roof assembly of FIG. 13;

FIG. 15 is a sectional view of a portion of the roof frame taken along line 15-15 of FIG. 14 and also showing a roof panel of the roof assembly coupled thereto;

FIG. 16 is a perspective view of a rear end wall assembly of the mobile storage container;

FIG. 17 is an inside view of a portion of the rear end wall assembly of the mobile storage container showing a spring-loaded latch coupled thereto;

FIG. 18 is a perspective view of a model-sized mobile storage container showing the roof assembly removed, a first one of the sidewall assemblies already folded to a stowed position atop the floor assembly, and the second one of the sidewall assemblies being folded to a stowed position;

FIG. 19 is a perspective view of the model-sized mobile storage container shown in FIG. 18 showing the second sidewall assembly folded to a stowed position atop the first sidewall assembly;

FIG. 20 is a side view of the mobile storage container showing the end wall assemblies of the container having been folded to a stowed position atop the second sidewall assembly; and

FIG. 21 is a side view of the mobile storage container in the stowed position showing the roof assembly positioned on the end wall assemblies of the container.

### DETAILED DESCRIPTION

For the purposes of promoting an understanding of the principles of the invention, reference will now be made to a number of illustrative embodiments shown in the attached drawings and specific language will be used to describe the same. While the concepts of this disclosure are described in relation to a mobile storage container, it will be understood that they are equally applicable to other storage containers generally, and more specifically to conventional box or van type trailers, examples of which include, but should not be limited to, straight truck bodies, small personal and/or commercial trailers and the like.

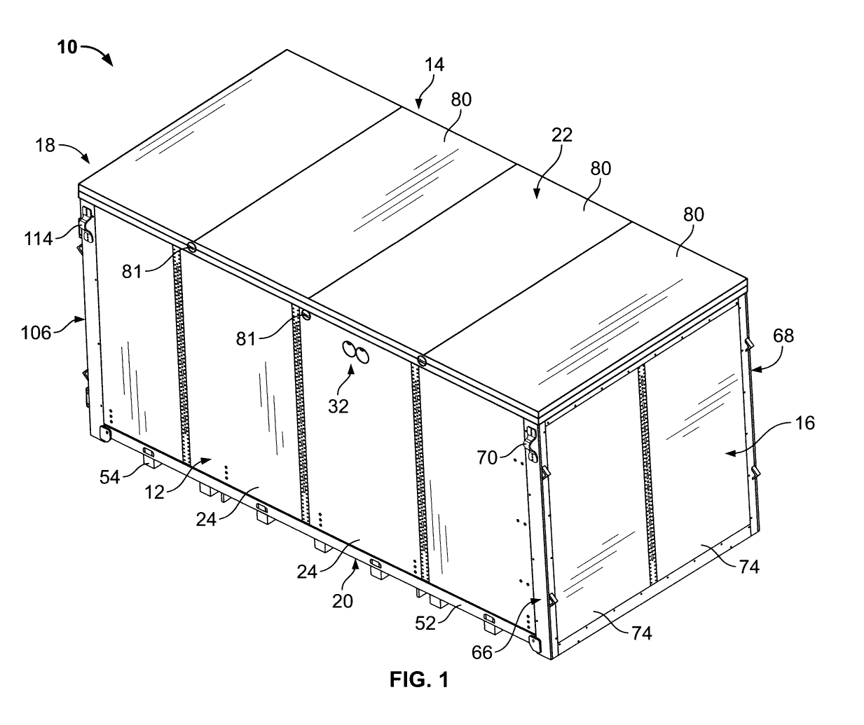

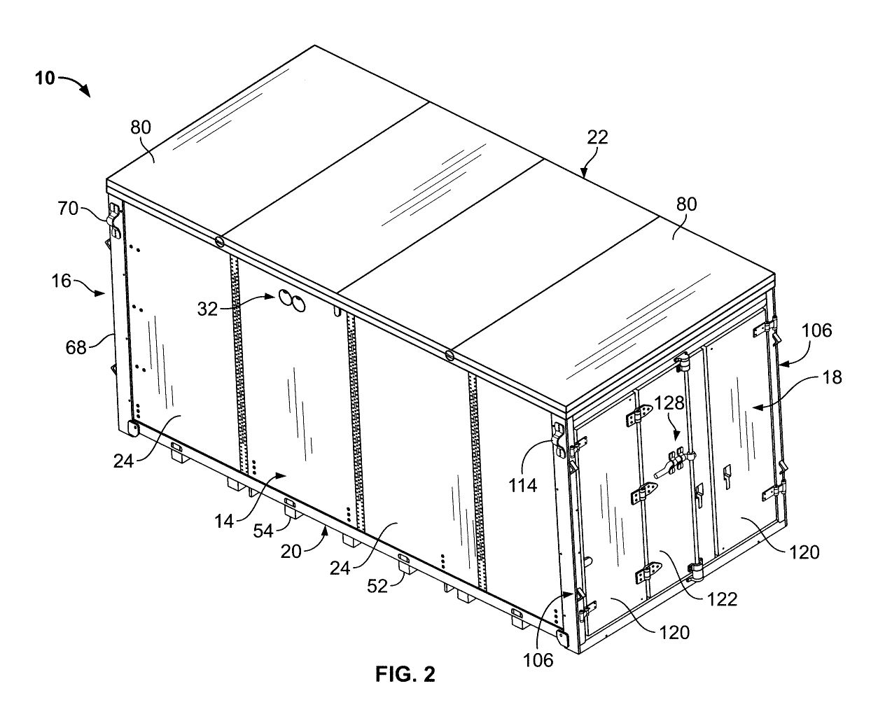

Referring now to FIGS. 1 and 2, a foldable storage container 10 is provided. Illustratively, the storage container 10 is shown in a use, or assembled, configuration in FIGS. 1 and 2 such that the storage container 10 defines an inside storage portion able to store various articles or goods therein. As is described in greater detail below, the storage container 10 is also configured to be folded to a stowed configuration, as shown in FIG. 4, for transportation of the container 10 from one site to another, for example.

The storage container 10 includes first and second sidewall assemblies 12, 14, a front end wall assembly 16, a rear end wall assembly 18, a floor assembly 20, and a roof assembly 22. Illustratively, the sidewall assemblies 12, 14 are each coupled to the front and rear end wall assemblies 16, 18 while the floor and roof assemblies 20, 22 are each coupled to the sidewall, front end, and rear end wall assemblies 12, 14, 16, 18. In particular, the sidewall, front end and rear end wall assemblies 12, 14, 16, 18 are each pivotally coupled to the floor assembly 20 for movement between a generally vertical, use position and a generally horizontal stowed position, as is discussed in greater detail below. Further, the roof assembly 20 is removably coupled to each of the sidewall and end wall assemblies 12, 14, 16, 18 and is removed therefrom when the mobile storage container 10 is moved to the stowed position.

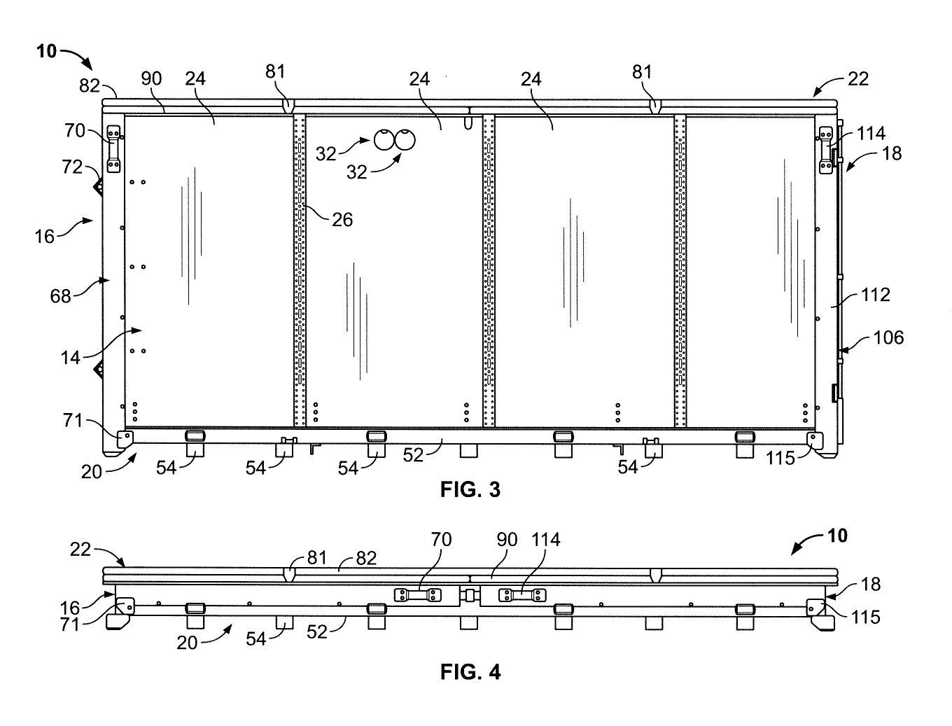

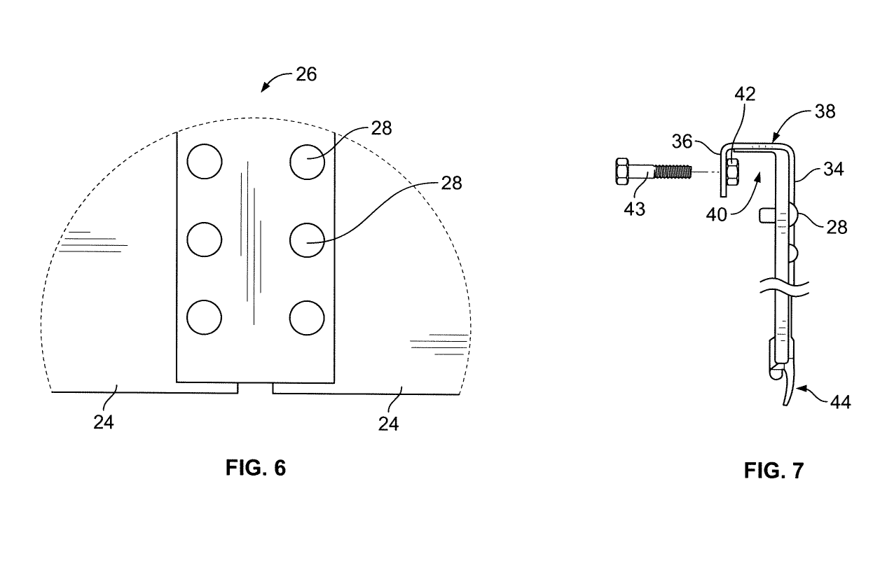

Looking now to FIGS. 3 and 5-7, the illustrative second sidewall assembly 14 includes four sidewall panels 24 coupled together by a vertical track or metal strip assembly 26 (shown in FIGS. 6 and 12) and rivets 28 inserted through holes in each metal strip assembly 26 in order to join adjacent sidewall panels 24 together. Illustratively, while the metal strip assemblies 26 are mounted to the sidewall panels 24 through the use of bolts, other fasteners such as rivets or screws, for example, may be used as well. Alternatively, the metal strip assemblies 26 may be formed integrally with the side wall panels. It is further within the scope of this disclosure to bond the assemblies 26 to the sidewall panels 24 using the method set forth in U.S. Provisional Patent Application No. 61/036,142 filed Mar. 13, 2008 titled “Method for Mounting Logistics Strips to an Inner Surface of a Storage Container Sidewall”, the disclosure of which is hereby incorporated by reference herein.

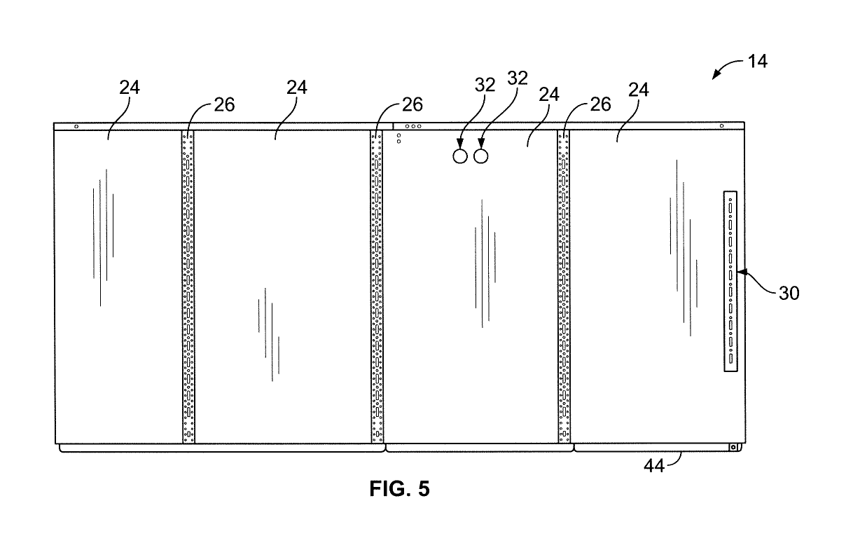

Further illustratively, the sidewall assembly 14 includes a vertical track series 30 coupled to one of the sidewall panels 24, as shown in FIG. 5. The vertical track series 30 is coupled to the front-most sidewall panel 24 in order to secure storage items or for holding load bars, shelves, clothing poles, storage racks, etc. to stack loads within the container 10, for example. Illustratively, the sidewall assembly 14 may include skylight assemblies 32, as shown in FIGS. 3 and 5. The skylight assemblies 32 are mounted to the sidewall assemblies 12, 14 of the container to allow the passage of light through the sidewall panels 24. These skylight assemblies 32 are illustratively coupled to the middle-front sidewall panel 24; however, it is within the scope of this disclosure to couple the skylight assemblies to any of the sidewall panels 24. In particular, any number of skylight assemblies 32 may be coupled to any sidewall panel 24 having apertures (not shown) formed therethrough which are configured to receive the skylight assemblies therein. Illustrative skylight assemblies, such as the skylight assemblies 32, are disclosed in greater detail in U.S. Provisional Patent Application No. 61/023,962 filed on Jan. 28, 2008 and titled “Vehicle Skylight and Method for Installing the Same”, the disclosure of which is hereby incorporated by reference herein.

Illustratively, each sidewall panel 24 of the sidewall assembly 14 includes an inner wall 34, an outer wall or lip 36, and a top wall 38 coupled to and positioned between the outer and inner walls 34, 36 to create a top rail defining a channel 40 therein. Further illustratively, a weld nut 42 is coupled to the outer wall 36 in order to receive a bolt 43 therein to couple the roof assembly 22 to the sidewall assembly 14 when the mobile storage container 10 is in the use position. It should be understood, however, that the roof assembly 22 may be coupled to each sidewall assembly 14 using other fasteners, such as rivets, screws, nails, welds, etc., and that the fasteners shown in FIG. 7 are merely illustrative of one type of fastener, i.e., nut and bolt, which may be used. In particular, as is discussed in greater detail below, the top rail of each sidewall panel 24, including the inner wall 34, outer wall 36, and top wall 38, is received within a channel 96 of a roof cap 90 of the roof assembly 22. The bolt 43 is then received through an aperture in the roof cap 90, through a corresponding aperture in the outer wall 36 of each sidewall panel 24 to be received by the weld nut 42 and secured thereto. Each sidewall panel 24 further includes a rubber trim 44 coupled to a bottom edge of the outer wall 36 to create a compression between the sidewall assembly 14 and the floor assembly 20 when the mobile storage container 10 is in the assembled, use configuration.

Illustratively, while the sidewall assembly 14 is shown and described in detail above, the sidewall assembly 12 includes the same or similar features as those of the sidewall assembly 14. In other words, the sidewall assemblies 12, 14 are generally identical in configuration and function. Accordingly, like reference numerals are used herein to denote like features. Furthermore, the sidewall panels 24 of the sidewall assemblies 12, 14 are illustratively composite panels made from a high-density polyethylene plastic core bonded between two high-strength steel skins. However, it is within the scope of this disclosure to provide sidewall panels 24 made from any suitable material.

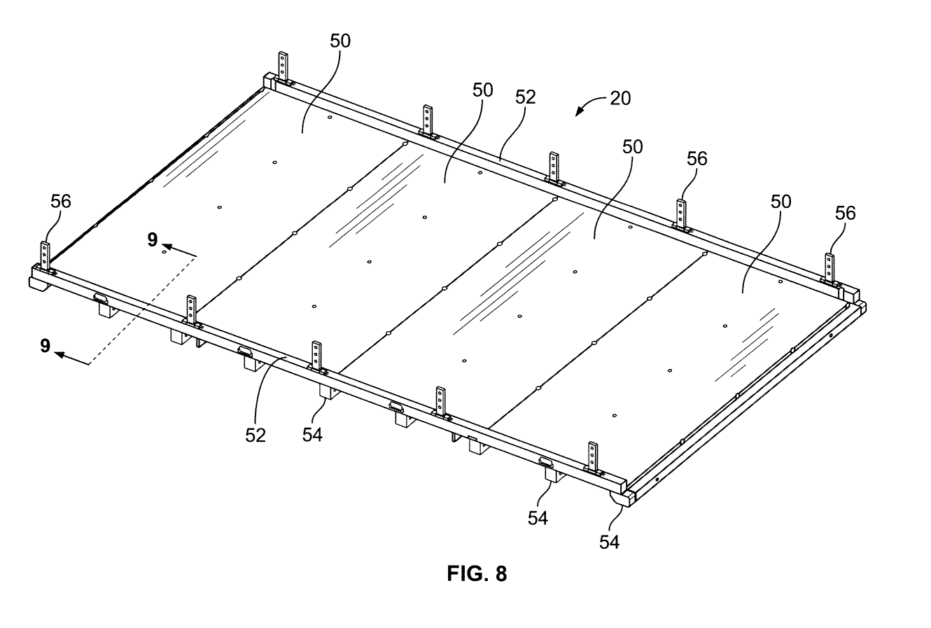

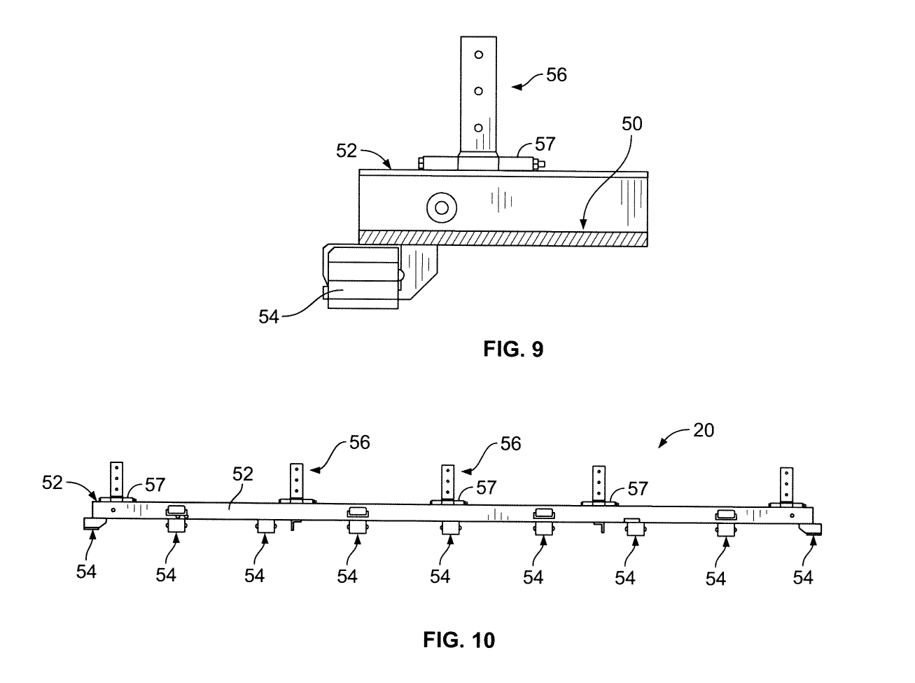

Looking now to FIGS. 8-10, the floor assembly 20 includes floor panels 50 coupled to each other to define an inner surface of the mobile storage container 10, first and second side beams 52 coupled to and extend along the top and bottom edge of each floor panel 50, as shown in FIG. 8. The floor assembly 20 further includes wood cross-members 54 coupled to and extending laterally across the outer surface of the container 10. Illustratively, the cross-members 54 are coupled to an outer surface of the floor panels 50. Metal brackets 56 of the floor assembly 20 are coupled to the first and second side beams 52 in order to fixedly couple the sidewall assemblies 12, 14 thereto. As is discussed in greater detail below, the each sidewall assembly 12, 14 is coupled to one of the first and second side beams 52 of the floor assembly 20 in order to couple the floor assembly 20 and the sidewall assemblies 12, 14 together. Illustratively, for example, bolts (not shown) are received through apertures in the brackets 56 and into a corresponding aperture (not shown) of the sidewall assemblies 12, 14 in order to couple the floor assembly 20 to the sidewall assemblies 12, 14.

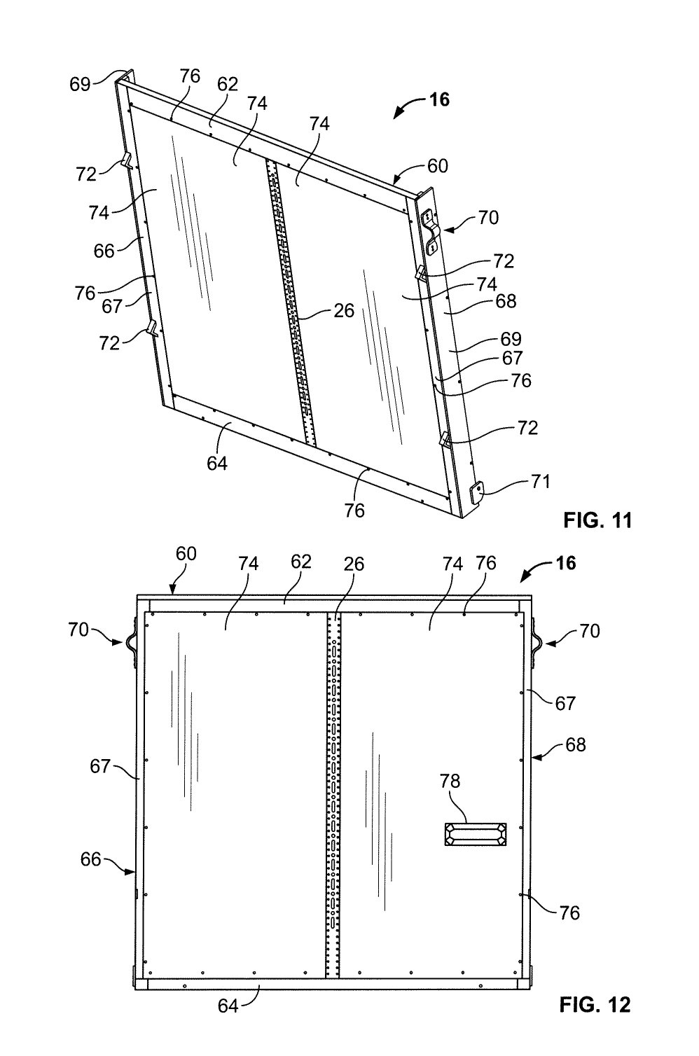

Looking now to FIGS. 11 and 12, the front end wall assembly 16 includes an outer frame 60 having upper and lower frame members 62, 64 as well as corner posts 66, 68 coupled to each of the upper and lower frame members 62, 64. Illustratively, each corner post 66, 68 includes an end frame member 67 and a side frame member 69 coupled to the end frame member 67 and positioned transverse to the end frame member 67 to create a corner therein. As is described in greater detail below, the sidewall assemblies 12, 14 are received within the corner area of each respective corner post 66, 68 and are engaged with the side frame member 69 of each corner post 66, 68. Illustratively, the corner posts 66, 68 further provide structural support for the roof assembly 22 when the mobile storage container 10 is in the assembled, use configuration. In other words, much of the weight of the roof assembly 22 is supported by the corner posts 66, 68. Further, as noted previously, the mobile storage containers 10 are oftentimes stacked in a use configuration on top of one another. As such, the corner posts 66, 68 of the front end wall assembly 16 further operate to provide structural support of the mobile storage container 10 to support the weight of any such additional containers 10 stacked thereon. Each corner post 66, 68 further includes a pivot plate 71 coupled to the side frame member 69. As is discussed in greater detail below, the pivot plate 71 is pivotally coupled to the floor assembly 20 via a pivot pin to allow the front end wall assembly 16 to pivot relative to the floor assembly 20 between the use and stowed configurations.

Illustratively, a handle 70 is coupled to each of the corner posts 66, 68. The handle 70 is a flexible strap that is bolted to each of the side frame members 69 to allow a user to more easily grip the front end wall assembly 16 when moving the assembly between the use configuration and the stowed configuration, as is discussed in greater detail below. Further illustratively, stowed stacking supports 72 are coupled to the outer surface of each of the corner posts 66, 68.

The front end wall assembly 16 further includes two front end wall panels 74 each coupled to each other and to the outer frame 60. As shown in FIGS. 11 and 12, inner and outer metal strip assemblies 26 are provided to couple the end wall panels 74 to each other. Further, rivets 76 are used to couple each of the front end wall panels 74 to the outer frame 60. Finally, the front end wall assembly 16 includes a canvas pouch 78 coupled to an inner surface of one of the end wall panels 74, as shown in FIG. 12. Illustratively, the canvas pouch 78 is provided to store the fasteners, such as bolts and/or screws, to used to assembly the sidewall, end wall and roof assemblies 12, 14, 16, 18, 22 when the container 10 is in the stowed position.

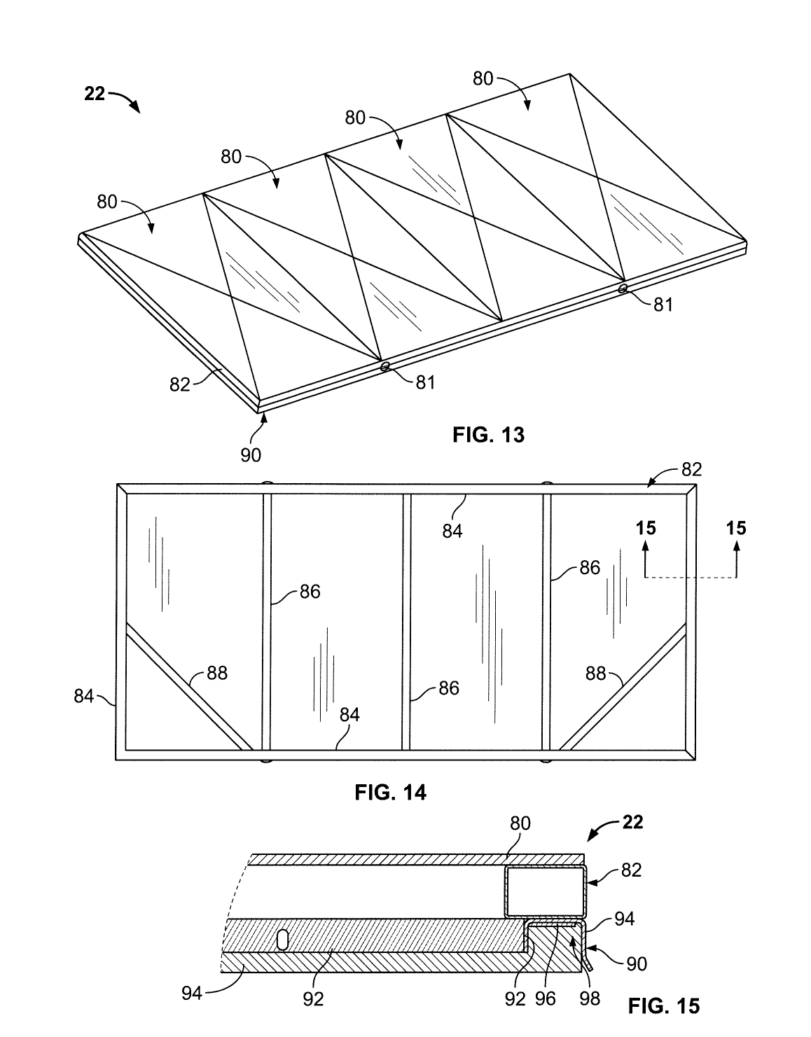

Looking now to FIGS. 13-15, the roof assembly 22 includes four roof panels 80 coupled to each other as well as a frame 82 coupled to an inner surface of the roof panels 80, as shown in FIG. 14. In particular, the frame 82 includes an end roof tube 84 coupled to and positioned around an outer perimeter of the assembled roof panels 80 as well as cross-braces 86 coupled to adjacent roof panels 80 and anti-rack braces 88. Illustratively, the cross-braces 86 and the anti-rack braces 88 are coupled to and extend between sections of the end roof tube 84. A roof cap 90 is coupled to the end roof tube 84 and includes an inner wall 92, an outer wall 94, and a top wall 96 coupled to and extending between the inner wall 92 and the outer wall 94 in order to define a roof channel 98 therein. As is discussed in greater detail below, the roof channel 98 is configured to receive a the top rail portion of the sidewall assemblies 12, 14 as well as an upper portion of the front and rear end wall assemblies 16, 18 therein when the mobile storage container 10 is in the assembled configuration.

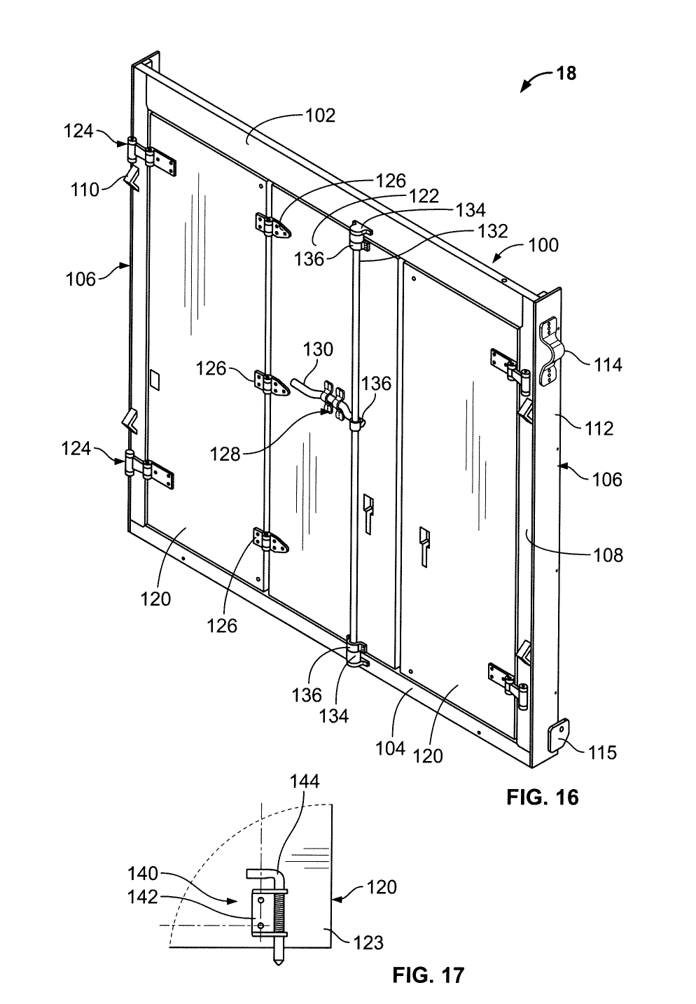

Looking now to FIGS. 16-19, the rear end wall assembly 18 includes an outer frame 100 having a door header 102, a door sill 104, and opposite corner posts 106 coupled to and extending between the door header 102 and the door sill 104. Illustratively, each corner post 106 includes a rear frame member 108 having stowed stacking supports 110 attached thereto and a side frame member 112 coupled to the rear frame member 108 and including a handle 114 attached thereto. Each handle 114 is a flexible strap that is bolted to each of the side frame members 112. As is discussed in greater detail below, the handles 114 are provided to aide a user in moving the rear end wall assembly 18 between the generally vertical, assembled configuration and the generally horizontal, stowed configuration. Further illustratively, stowed stacking supports 72 are coupled to the outer surface of each of the corner posts 66, 68.

Each corner post 106 further includes a pivot plate 115 coupled to the side frame member 112 of each corner post 106. As is discussed in greater detail below, the pivot plate 115 is pivotally coupled to the floor assembly 20 via a pivot pin to allow the rear end wall assembly 18 to pivot relative to the floor assembly 20 between the use and stowed configurations. As is discussed above with regard to the front end wall assembly 16, the sidewall assemblies 12, 14 are received within the corner area of each respective corner post 106 and are engaged with the side frame member 112 of each corner post 106 when the container 10 is in the use configuration. Illustratively, the corner posts 106, as with the corner posts 66, 68 of the front end wall assembly 16, further provide structural support for the roof assembly 22 when the mobile storage container 10 is in the assembled, use configuration. In other words, much of the weight of the roof assembly 22 is supported by the corner posts 106 as well as the corner posts 66, 68. Additionally, as discussed above in regard to the corner posts 66, 68 of the front end wall assembly 16, the corner posts 106 of the rear end wall assembly 18 further provide structural support of the mobile storage container 10 to support the weight of any such additional mobile storage containers 10 stacked thereon.

Illustratively, the rear end wall assembly 18 further includes outer door panels 120 and a center door panel 122 positioned between and pivotally coupled to the outer door panels 120, as shown in FIG. 16. Illustratively, each of the outer door panels 120 is pivotally coupled to an adjacent rear frame member 108 of the corner posts 106 by hinges 124. As shown in FIG. 16, two hinges 124 are coupled to the left door panel 120 and the left side frame member 106 in order to allow the left door panel 120 to move between opened and closed positions relative to the outer frame 100. Similarly, another two hinges 124 are coupled to the right door panel 120 and the right side frame member 106 in order to allow the right door panel 120 to move between opened and closed positions relative to the outer frame 100. The center door panel 122 is pivotally coupled to the left door panel 120 by a set of hinges 126 in order to allow the center door panel 122 to move between opened and closed positions relative to the left door panel 120. As is discussed below, this three-door panel configuration allows for multiple options in opening and closing the entryway into the mobile storage container 0.

The rear frame assembly 118 further includes a handle assembly 128 coupled to the center door panel 122 and the outer frame 100 in order to maintain the outer door panels 120, 122 in a closed and locked position. Illustratively, the handle assembly 128 includes a handle 130 coupled to the center door panel 122 and a lock rod 132 coupled to the handle 130 and configured to extend along a height of the center door panel 122. Illustratively, each end of the lock rod 132 terminates in a bracket 134 coupled to the door header 102 and the door sill 104 of the frame 100. Additional rod guides 136 are coupled to the center door panel 122 in order to guide upward and downward movement of the lock rod 132 by rotation of the handle 130. While the particular handle assembly 128 is shown and disclosed herein, it is within the scope of this disclosure to include any suitable handle assembly.

Illustratively, the outer door panels 120, 122 may be locked from within the mobile storage container 10 via spring-loaded latches 140 coupled to inside surface (not shown) of the top and bottom inner corners of each of the outer door panels 120. In other words, a first latch 140 is coupled to the inner surface of the bottom inner corner of the left outer door panel 120; a second latch 140 is coupled to the inner surface of the top inner corner of the left outer door panel 120; a third latch 140 is coupled to the inner surface of the bottom inner corner of the right outer door panel 120; a fourth latch 140 is coupled to the inner surface of the top inner corner of the right outer door panel 120. Illustratively, as shown in FIG. 17, each latch 140 includes a bracket 142 coupled to the respective outer door panel 120 and a locking pin 144 movably received within the bracket 142. The locking pins 144 of the bottom two latches 140 are received within an aperture (not shown) of the door sill 104 when the locking pins 144 are in the locked position. Similarly, the locking pins 144 of the top two latches 140 are received within an aperture (not shown) of the door header 102 when the locking pins 144 are in the locked position. Each latch further includes a spring (not shown) biasing the locking pin 144 to an unlocked position removed from the respective aperture of the frame 100. Thus, these inner latches 140 allow a user within the container 10 to close and lock the outer door panels 120, 122 from inside the container 10.

As noted above, the rear end wall assembly 18 includes three door panels: a left outer door panel 120, a center door panel 122, and a right outer door panel 120. This three-door configuration allows the door panels 120, 122 to be opened relative to the frame 100 in a number of different configurations depending on the needs of the user and the size of the items being taken in and out of the mobile storage container 10. In particular, the center door panel 122 may be opened relative to the outer door panels 120 to provide a narrow, central passageway into the mobile storage container 10. Alternatively, the center door panel 122 may be opened relative to the outer left door panel 120 and the right door panel 120 may also be opened relative to the outer frame 100 to provide a wider passageway through approximately the right two-thirds of the rear end wall assembly 18 into the container 10. Illustratively, the outer right door panel 120 may be pivoted approximately 270° to lie adjacent to the sidewall assembly 12 when in the opened position. Similarly, the center door panel 122 may be opened relative to the right door panel 120 and the left door panel 120 (with the center door panel 122 hingedly attached thereto) may be opened relative to the outer frame 100 to provide a wider passageway through approximately the left two-thirds of the rear end wall assembly 18 into the container 10. Finally, all three outer door panels 120, 122 may be opened to provide a passageway having a width generally the same as a width between the corner posts 106 of the frame 100.

Further illustratively, the three door panels 120, 122 each include compression and wiper seals 44 to provide a sealed connection between the each adjacent door panel 120, 122 as well as the outer frame 100. It should also be understood that while the rear end wall assembly 18 includes the three outer door panels 120, 122, it is within the scope of this disclosure for the front end wall assembly 16 to include the door panels 120, 122 as well. In other words, the front and rear end wall assemblies 16, 18 are interchangeable with each other.

As noted above, the mobile storage container 10 may be moved between a use configuration, as shown in FIGS. 1 and 2, and a stowed configuration, as shown in FIGS. 4 and 21. Illustratively, in the use configuration, the mobile storage container 10 is fully assembled and ready to receive items for storage therein. Illustratively, the mobile storage container 10 is approximately 16 feet long, 9 feet tall, and 7.7 feet wide. However, it is within the scope of this disclosure to provide a storage container having any suitable dimensions for storing any number and size of items therein. In order to assemble the mobile storage container 10, the sidewall assemblies 12, 14 and the front and rear end wall assemblies 16, 18 are coupled to the floor assembly 20. In particular, the sidewall assemblies 12, 14 each include compression and wiper seals 44 coupled to a bottom edge of the sidewall panels 24 of the assemblies 12, 14 in order to provide a seal between the sidewall panels 24 to the floor assembly 20. Further, the sidewall assemblies 12, 14 each include compression seals (not shown) coupled to a side edge of the front-most and rear-most sidewall panels 24 in order to provide a seal between the sidewall assemblies 12, 14 and the front and rear end wall assemblies 16, 18.

As noted previously, the sidewall panels 24 of the sidewall assemblies 12, 14 are bolted or otherwise fastened to the metal brackets 56 of the floor assembly 20 in order to fixedly coupled the sidewall assemblies 12, 14 to the floor assembly 20 when the mobile storage container 10 is in the assembled, use configuration. Furthermore, the sidewall assemblies 12, 14 are also bolted or otherwise fastened to the front and rear end wall assemblies 16, 18 in order to coupled the sidewall assemblies 12, 14 thereto when the mobile storage container 10 is in the assembled, use configuration. The sidewall assemblies 12, 14 are also hingedly coupled to the floor assembly 20 via hinges 57 in order to allow the sidewall assemblies 12, 14 to pivot relative to the floor assembly 20. In particular, the sidewall panels 24 of the sidewall assemblies 12, 14 are hingedly coupled at a bottom edge thereof to the floor assembly 20. Illustratively, the hinges 57 are pivot hinges and each include the first bracket 56 coupled to one of the respective sidewall assemblies 12, 14 and a second bracket (not shown) coupled to the floor assembly 20. While pivot hinges 57 are shown and described herein, it is within the scope of this disclosure to include other suitable hinges as well.

The front and rear end wall assemblies 16, 18 are illustratively coupled to the floor assembly 20 via the respective pivot plates 71, 115. This pivoting connection allows the front and rear end assemblies 16, 18 to pivot relative to the floor assembly 20 when moving between the assembled, use configuration and the stowed configuration. In use, the roof assembly 22 is placed onto the sidewall assemblies 12, 14 and the front and rear end wall assemblies 16, 18 such that the top rail of each of the sidewall assemblies 12, 14 is received within the channel 96 of the roof assembly 22. As noted above, the bolt 43 is received through an aperture in the inner wall 92 of the roof cap 90 of the roof assembly 22 and into the weld nut 42 of each sidewall assembly 12, 14 in order to couple the roof assembly 22 to the sidewall assemblies 12, 14 when the mobile storage container 10 is in the use position.

In use, the mobile storage container 10 is moved from the use or assembled configuration shown in FIGS. 1 and 2 to the stowed configuration shown in FIGS. 4 and 21 by first removing the fasteners which couple the roof assembly 22 to the sidewall assemblies 12, 14 and front and rear end wall assemblies 16, 18. As noted above, therefore, the roof assembly 22 is removably coupled to each of the side and end wall assemblies 12, 14, 16, 18 and is removed therefrom when the mobile storage container 10 is moved from the use configuration to the stowed configuration. Illustratively, such fasteners are removed from the inside of the container 10. As noted above, the fasteners are bolts (not shown) which are received through the roof channel 98 and into the channel 40 of each top rail of the sidewall assemblies 12, 14.

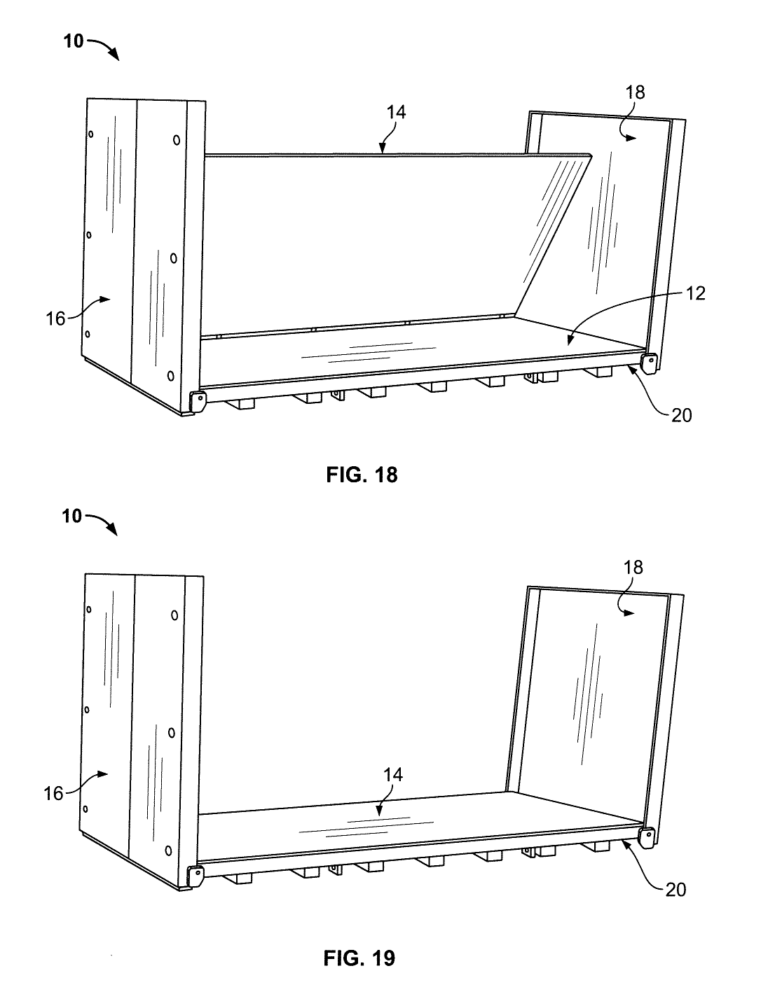

Next, a fork lift (not shown) or other lift system is coupled to D-rings 81 of the roof assembly 22, shown in FIG. 13. The fork lift is then used to lift and remove the roof assembly 22 from the sidewall assemblies 12, 14 and the front and rear end wall assemblies 16, 18. The fork lift is next coupled to D-rings 81 of the first sidewall assembly 12 and the fasteners connecting this first sidewall assembly 12 to the front and rear end wall assemblies 16, 18 of the container 10 are removed. The fork lift is then used to fold the sidewall assembly 12 inward to rest on top of the floor assembly 20, as shown in the mobile storage container 10 of FIG. 18. Illustratively, the first sidewall assembly 12 is pivoted inwardly from a generally vertical position to a generally horizontal position. The second sidewall assembly 14 is folded in a similar manner. In other words, the fork lift is coupled to the D-rings 81 of the second sidewall assembly 14 and the fork lift is then used to fold the second sidewall assembly 14 inwardly, as shown in FIG. 18, for example, to rest on top of the first sidewall assembly 12, as shown in FIG. 19.

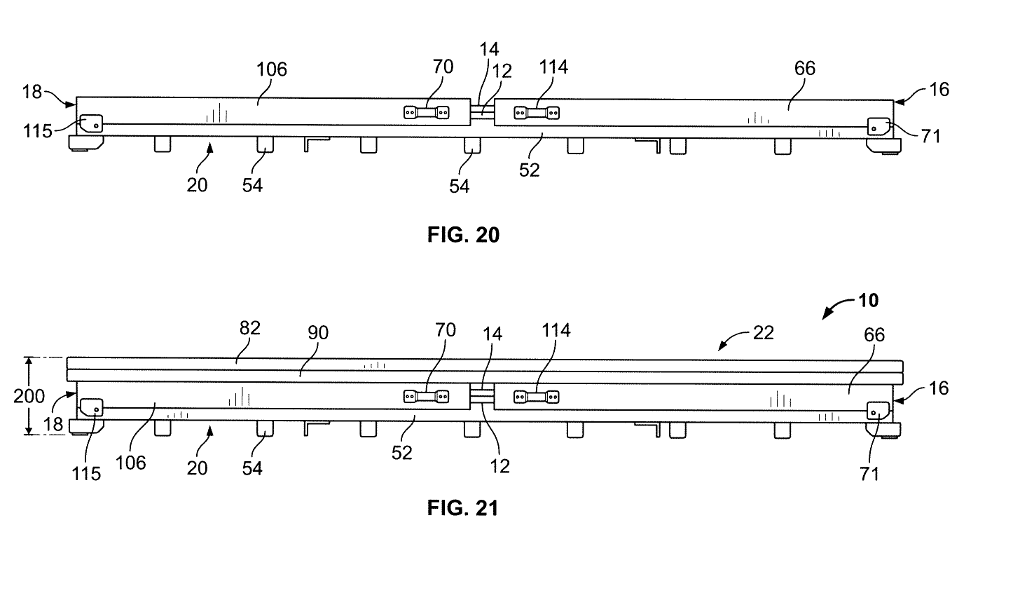

The fasteners connecting each of the front and rear end wall assemblies 16, 18 to the floor assembly 20 are then manually removed. Each of the front and rear end wall assemblies 16, 18 is then folded down manually to rest on top of and adjacent to the second sidewall assembly 14, as shown in FIG. 20. As discussed above, the front end wall assembly 16 is pivoted relative to the floor assembly 20 about the pivot pin connecting the pivot plate 71 of the front end wall assembly 16 to the floor assembly 20. Similarly, the rear end wall assembly 18 is pivoted relative to the floor assembly about the pivot pin connecting the pivot plate 115 of the rear end wall assembly 18 to the floor assembly 20. Illustratively, a user may grab the handles 70, 114 coupled to the respective front and rear end wall assemblies 16, 18 in order to manually pivot the end wall assemblies 16, 18 from the generally vertical, assembled position to the generally horizontal, stowed position.

Finally, the fork lift is coupled again to the D-rings 81 of the roof assembly 22 and the roof assembly 22 is placed on top of the now-folded front and rear end wall assemblies 16, 18, as shown in FIG. 21, to provide the mobile storage container 10 in the stowed configuration. Illustratively, multiple storage containers 10 which are in their stowed configuration may be stacked on a flatbed truck, for example, for transport from one location to another. Such stacked mobile storage containers 10 may be strapped down on the flatbed of the truck using banding or other cables.

Illustratively, in the stowed configuration, the mobile storage container 10 has a total stowed height 200 of approximately 17 inches. In particular, the total stowed height 200 of the storage container 10 in the stowed configuration is 16.63 inches. However, it is within the scope of this disclosure to provide a mobile storage container having any suitable height when in the stowed configuration.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A foldable mobile storage container comprising:
a floor assembly;
a first sidewall assembly pivotally coupled to the floor assembly;
a second sidewall assembly pivotally coupled to the floor assembly;
a rear end wall assembly pivotally coupled to the floor assembly;
a front end wall assembly pivotally coupled to the floor assembly; and
a roof assembly configured to be coupled to the first and second sidewall assemblies and to the rear and front end wall assemblies.

2. The foldable mobile storage container of claim 1, wherein the floor assembly includes a first hinge coupled to the first sidewall assembly and the floor assembly, and a second hinge coupled to the second sidewall assembly and the floor assembly.

3. The foldable mobile storage container of claim 1, wherein the rear end wall assembly includes an outer door frame and first, second, and third door panels pivotally mounted to the door frame.

4. The foldable mobile storage container of claim 3, wherein the second door panel is positioned between the first and third door panels.

5. The foldable mobile storage container of claim 4, wherein the second door panel is pivotalby mounted to the first door panel, the first door panel is pivotalby mounted to the outer door frame, and the third door panel is pivotalby mounted to the outer door frame.

6. The foldable mobile storage container of claim 3, wherein the rear end assembly includes a door handle assembly coupled to the second door panel.

7. The foldable mobile storage container of claim 3, wherein the rear end assembly further includes a first spring-loaded latch coupled to the first door panel, a second spring-loaded latch coupled to the second door panel, and a third spring-loaded latch coupled to the third door panel.

8. The foldable mobile storage container of claim 1, wherein the roof assembly includes an outer frame and a roof cap coupled to the outer frame to define a roof channel extending around the perimeter of the roof assembly.

9. The foldable mobile storage container of claim 8, wherein the roof channel is configured to receive the first and second sidewall assemblies and the front and rear end assemblies therein.

10. The foldable mobile storage container of claim 9, wherein the roof cap includes an inner wall, an outer wall, and an upper wall coupled to and positioned between the inner wall and the outer wall such that the roof channel is defined between the inner and the outer wall.

11. The foldable mobile storage container of claim 1, wherein the front end assembly includes an outer frame having first and second corner posts each including a front wall member and a sidewall member coupled to the front wall member and positioned generally transverse to the front wall member.

12. The foldable mobile storage container of claim 1, wherein the rear end assembly includes an outer frame having first and second corner posts each including a front wall member and a side wall member coupled to the front wall member and positioned generally transverse to the front wall member.

13. The foldable mobile storage container of claim 1, wherein the mobile storage container is movable between a use configuration to define a storage area therein and a stowed configuration.

14. The foldable mobile storage container of claim 13, wherein the first and second sidewall assemblies and the front and rear end assemblies are in a generally vertical position when the mobile storage container is in the use position and are in a generally horizontal position when the mobile storage container is in the stowed position.

15. The foldable mobile storage container of claim 13, wherein the first sidewall assembly is positioned atop the floor assembly, the second sidewall assembly is positioned atop the first sidewall assembly, the front and rear end assemblies are each positioned atop the second sidewall assembly, and the roof assembly is positioned atop both the front and rear end assemblies when the mobile storage container is in the stowed position.

16. A foldable mobile storage container comprising:
a floor assembly;
first and second sidewall assemblies pivotally coupled to the floor assembly;
wherein the floor assembly includes a first hinge coupled to the first sidewall assembly and the floor assembly and a second hinge coupled to the second sidewall assembly and the floor assembly;
wherein the mobile storage container is movable between a use configuration to define a storage area therein and a stowed configuration wherein the first and second sidewall assemblies are pivoted to a generally horizontal position atop the floor assembly.

17. The foldable mobile storage container of claim 16, wherein the floor assembly includes a third hinge coupled to the first sidewall assembly and a fourth hinge coupled to the second sidewall assembly, and further wherein each of the first, second, third, and fourth hinges are pivot hinges including a first bracket coupled to the floor assembly and a second bracket coupled to one of the respective first and second sidewall assemblies.

18. The foldable mobile storage container of claim 16, further comprising first and second end wall assemblies pivotally coupled to the floor assembly.

19. The foldable mobile storage container of claim 18, further comprising a first pivot plate of the first end wall assembly pivotably coupled via a first pivot pin to a side beam of the floor assembly, and a second pivot plate of the second end wall assembly pivotably coupled via a second pivot pin to the side beam of the floor assembly.

20. The foldable mobile storage container of claim 18, wherein the front and rear end assemblies are pivoted to a generally horizontal position when the mobile storage container is in the stowed configuration.

21. The foldable mobile storage container of claim 20, wherein the front and rear end assemblies are positioned atop the first and second sidewall assemblies when the mobile storage container is in the stowed configuration.

22. The foldable mobile storage container of claim 16, wherein the first and second side wall assemblies each include a plurality of metal wall panels.

23. The foldable mobile storage container of claim 16, further comprising a roof assembly configured to be coupled to the first and second sidewall assemblies when the mobile storage container is in the use configuration, and uncoupled from and configured to lie atop the first and second sidewall assemblies when the mobile storage container is in the stowed configuration.

24. A method of folding a mobile storage container from a use configuration defining a storage area therein to a stowed configuration, the method comprising:
removing a roof assembly of the mobile storage container;
pivoting a first sidewall assembly from a generally vertical position to a generally horizontal position atop the floor assembly;
pivoting a second sidewall assembly from a generally vertical position to a generally horizontal position atop the first sidewall assembly;
pivoting a rear end assembly from a generally vertical position to a generally horizontal position atop the second sidewall assembly;
pivoting a front end assembly from a generally vertical position to a generally horizontal position atop the second sidewall assembly; and
placing the roof assembly atop the rear and front end assemblies.
